(19) United States
(12) Patent Application Publication
(10) Pub. No.: US 2010/0216902 A1
(43) Pub. Date: Aug. 26, 2010

(54) Method for the pretreatment, reprocessing or recycling of thermoplastic material

(75) Inventors: Gerhard Wendelin, Linz (AT); Klaus Feichtinger, Linz (AT); Manfred Hackl, Linz-Urfahr (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EREMA ENGINEERING RECYCLING MASCHINEN UND ANLAGEN GESELLSCHAFT M.B.H. FREINDORF UNTERFELDSTRASSE 3, AUSTRIA (AU)

(21) Appl. No.: 12/514,070

(22) PCT Filed: Nov. 13, 2007
(86) PCT No.: PCT/AT07/00515

§ 371 Date: Nov. 5, 2009

(30) Foreign Application Priority Data
Nov. 13, 2006 (AT) 1880/2006

(51) Int. Cl. C08J 11/04

(52) U.S. Cl. 521/47; 521/40; 521/40.5

(57) ABSTRACT

The invention relates to a method for the pretreatment, reprocessing or recycling of thermoplastic material, wherein the plastic material to be treated is heated in at least one receptacle or reactor while undergoing constant mixing or movement and/or comminution at a temperature below the melting temperature of the plastic material, and as a result is at the same time crystallized, dried and/or purified, wherein at least one rotatable comminuting or mixing tool, with working edges that act on the material with a comminuting and/or mixing effect, is used for the mixing and/or heating of the plastic material, the heating taking place in particular by applying mechanical energy.

The invention pertains to a method for the pretreatment, reprocessing or recycling of thermoplastic material according to claim 1.

The reprocessing of plastic waste has become an increasingly important issue at the present day. In any case, many problems are involved in an efficient recycling and they need to receive consideration. Thus, for example, the plastics being handled are usually wastes of the most diverse form, shape, thickness, etc. Furthermore, the individual plastics have chemical and physical properties differing from each other. Also, most plastics for recycling are polluted with toxic substances or other contaminants and require a cleaning in order to become marketable once more.

There are many different methods for recovering and recycling plastics. However, these methods always address only individual aspects, so that the methods known in the prior art are suitable for special applications, but fail in other fields and for other requirements and problems.

Thus, for example, it is important in the recycling of (particularly hygroscopic) plastics that the product being recycled is as dry as possible, to prevent a hydrolytic decomposition of the molecular chains during the plasticization or upon melting. This has to be taken into consideration by the process management.

Problems of process technology, such as stickiness of many plastics at high temperatures, also have to be given consideration.

The increasing reuse of recycled plastics has also led to the use of recycled goods in the field of food product packaging. But where a direct contact occurs between the recycled plastic and the food product, it must be assured that no unwanted contaminations get into the food product from the packaging material made from the recycled plastic. To solve this problem, numerous methods have already been developed to recycle used plastics, and therefore contaminated and often having toxic impurities in regard to food products, so that the resulting recycled plastic can again be used in the field of food product packaging with no problems.

First of all, chemical methods are known here. Thus, it was proposed to subject used plastics to a pyrolysis, whereupon the plastic is decomposed under exclusion of the oxygen of air. Another chemical recycling method involves the hydrogenation of plastics, whereupon a chemical reaction with hydrogen occurs at elevated pressure and elevated temperature. While these chemical methods have the benefit that the resulting plastics are largely free of toxic fractions, there are energy concerns and the specific plant expenditure standing in the way of an economical application.

On the other hand, physical methods work with much lower temperatures, so that the structure and especially the molecular chain length of the recycled plastic remains essentially intact.

An increasingly important plastic is polylactic acid or polylactide, hereinafter called PLA. Polylactic acid or PLA is a thermoplastic synthetic with formula

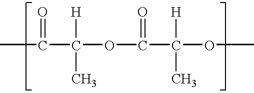

PLA [26100-51-6] belongs to the family of the polyesters. The optically active polymers occur in the form of D- or L-lactides.

PLA finds its greatest area of application in the packaging industry. One positive property of this substance is that it has a very good biodegradability, is biocompatible and friendly to the environment, and thus can easily be broken down by microorganisms.

The medical application of PLA is likewise of interest. Thus, implants or active ingredient vehicles are made of PLA and broken down in the human body. A bone plate and/or a screw of PLA is broken down in the body as the healing of a fractured bone progresses, so it no longer has to be removed in a second operation. The resorption period can be adjusted by the mixture ratio of L and D components, as well as the chain length of the polymer used. PLA sponges with active ingredients embedded in them can release these locally in a defined period of time.

The properties of PLA depend primarily on the molecular mass, the degree of crystallinity, and possibly the proportion of copolymers. A higher molecular mass raises the glass transition temperature, as well as the melting temperature, the tensile strength, and the E modulus, and lowers the strain after fracture. Due to the methyl group, the material has water-repellant or hydrophobic behavior. PLA is soluble in many organic solvents, such as dichlormethane or the like. PLA can also be fiber-reinforced for processing.

PLA polymers are obtainable primarily by the ionic polymerization of lactide, a ring closure of two lactic acid molecules. At temperatures between 140° and 180° C. and under the action of catalytic tin compounds (such as tin oxide), a ring opening polymerization takes place. Thus, plastics with a high molecular mass and strength are produced. Lactide itself can be made by fermenting of molasses or glucose by means of various bacteria. High-molecular and pure PLA can also be produced directly from lactic acid by polycondensation. However, the disposal of the solvent is a problem in the industrial production.

The glass transition point or range of PLA lies between 55° and 58° C., the crystallization temperature between 100° and 120° C. and the melting temperature between 165° and 183° C.

In the recycling of PLA plastics it is important that the material being recycled is as dry as possible, in order to prevent a hydrolytic breakdown of the molecular chains during the plasticization or the decomposition. However, PLA is hygroscopic, which makes an efficient drying difficult.

The low glass transition point at which the PLA material becomes sticky at higher temperatures, and a relatively long crystallization time, make it hard to crystallize and/or dry amorphous production wastes, especially residues of deep-drawn films, with conventional crystallization systems and drying systems.

Such conventional drying systems, known from the prior art, are dry air dryers, which operate at an air flow of around 1.85 m³/h and kg of granulate. For example, noncrystalline PLA is dried at 45° C., for ca. 4 h, at a dew point of −40° C., and crystallized PLA at 90° C., for ca. 2 h, at a dew point of −40° C.

But due to the rather low drying temperatures, especially when processing noncrystallized material, the drying time is relatively long and an extremely precise temperature management is necessary. This is extremely difficult, if not impossible, for granulates and especially for all other forms, such as flakes, films, fleece, etc.

For this reason, one can try to achieve a crystallization of the plastic prior to a drying. Such a crystallization can be achieved, for example, by moving or mechanically manipulating the particles uniformly at a temperature lower than the drying temperature, in any case at a temperature lower than the melting or plasticization temperature. The movement is advantageous for preventing a sticking together of the individual particles.

But since the materials intended for recycling are usually contaminated and are subjected to a washing and, if need be, a preceding comminution with simultaneous soiling, usually there comes first a defined comminution or a milling, a washing and a drying. Such a preliminary drying should not exceed¹ at least the water content to a value of less than 1.5 wt. % of the plastic material being used or recycled. ¹As printed, the verb chosen is wrong for the rest of the sentence.

If one goes straight to an early crystallization step with a conventional crystallizer, that also is extremely difficult and stickiness is the order of the day.

Complicating the course of a process for reprocessing of plastics is the fact that very different plastics are used for the most diverse of applications, differing substantially from each other in their chemical and physical properties. Thus, for example, PET has entirely different properties from PE, or PS has different properties from PP.

It is therefore not easily possible to apply or transfer directly the knowledge gained in the reprocessing of a polymer material to a different material. Each polymer thus requires its own special consideration and assessment, and especially process conditions tailored to the particular material. The precise process control will moreover also be influenced by the form and especially the thickness of the material being handled.

Since, furthermore, the parameters of crystallization, drying, cleaning and increasing the viscosity, e.g., also constitute a complex interplay, which can only be predicted in advance with difficulty and does not allow for any generally applying rules, a special adaptation of the process parameters is needed in each individual case for each polymer and for each kind and form of wastes being recycled.

Thus, the purpose of the present invention is to create a method by which many different plastics can be reprocessed in a gentle, efficient and economical way.

Moreover, this method should make it possible to treat sensitive or unstable, especially hygroscopic, plastics or plastics with elevated moisture content, in gentle manner.

Furthermore, it is the problem of the invention to create a method with which plastics being recycled, especially polylactic acid PLA, can be dried and possibly crystallized in one step at the same time, regardless of their kind, form and composition.

Moreover, it is the problem of the invention to provide a method with which plastics can be subjected to a quick and as energy saving as possible a recycling, wherein the recycled, recovered plastics or the granulate made with the resulting melt or articles made from the granulate have the highest possible values for viscosity and in particular a viscosity comparable to the viscosity values of the material being recycled. The viscosity value of the regranulate should be increased.

Moreover, it is the problem of the invention to provide a method with which heavily soiled or contaminated or highly imprinted plastics can be reprocessed without adversely affecting the mechanical properties of the plastic and/or its melt properties. The recycled, recovered plastics or the resulting plastic melt or the granulate produced from the melt should be food product pure, i.e., especially satisfy the food product regulations and be suitable for use in food products or be certified according to the European ILSI document or FDA. Thus, toxins, migration products or contaminants contained in the material sent for recycling should be removed by the method as completely as possible.

These problems are solved by the features of claim 1.

According to claim 1, chemically different plastics can be advantageously reprocessed regardless of their form. This ensures increased flexibility in the process control and the most diverse of plastics can be handled.

The crystallization, the drying, the purification or detoxication, possibly also the raising of the viscosity in the case of certain polycondensates, such as PA, possibly also PC, advantageously occur at the same time, especially in a single common process step. Thus, the reprocessing is fast, yet still gentle.

Thus, for example, both crystallized and uncrystallized polymer material in any previously comminuted or loosely flowing form in any desired mix ratios can be dried and, if necessary, crystallized in a single step and, if desired, be fed directly to an extruder in which the material is melted.

For the method of the invention, the mild, yet constant movement of the polymer material described in claim 1 is advantageous. This prevents clumping or sticking of the material in the critical temperature range, until an adequate crystallization of the surface of the particles itself prevents a sticking together of the individual particles. Furthermore, a higher process temperature is possible thanks to the movement. In the treatment tank, the mild and constant movement ensures not only an abeyance of sticking, but at the same time also ensures that the temperature in the tank is or remains high enough and each particle is or remains heated gently to the proper temperature. At the same time, the movement supports a detachment of the migrating molecules from the surface of the particles. For this purpose, one will advantageously use tools at different levels for continuous processes or mixing tools for batch processes.

Advantageous embodiments of the method are achieved by the features of the subclaims.

An improved drying of the plastic material is achieved, for example, by vacuum support. A process managed in this way also requires less energy input than comparable systems, thanks to the use of a vacuum.

The vacuum applied supports the diffusion process of impurities from the material and also ensures that they are carried away.

Moreover, the vacuum protects the hot polymer particles or flakes from oxidative influences or damage, so that a higher viscosity can also be achieved as compared to other plant systems. Basically, the detoxication could also be done with any inert gas. But this involves considerably higher costs.

The drying is supported by a certain advantageous minimum dwell time of the material at the temperature setting and possibly by the vacuum selected.

A complicated and cost-intensive traditional external predrying and crystallization of the processed material and the use of chemical additives and/or a solid state condensation are not required.

The input material for reprocessing is primarily packages from the food industry, such as milk bottles, yogurt cups, etc. These packages are freed from the usual coarse impurities in a first step in the upstream collecting, sorting, comminuting and washing layout. However, the smallest impurities remain, which have diffused into the outermost layer of the package.

For this purpose, the washed and dried flakes are subjected to the purification process of the invention under elevated temperature and possibly vacuum, while the dwell time in the reactor under the specified process conditions also plays a role for the decontamination. The process parameters depend on the inertness and the chemical and physical properties of the polymer involved.

How the temperature is brought into the material is not critical. It can occur in an upstream process or in the treatment tank. Advantageously, however, this occurs through the rotating mixing tools themselves.

Since the migration products are found in the boundary layer of the polymer particles, the diffusion paths are drastically shortened as compared to an extrusion process with subsequent degassing of the melt.

Basically the method of the invention can run in a batch process or continuously. Advantageously, one only needs to ensure that the process parameters such as temperature, dwell time and vacuum are maintained over the entire time. A continuous process has proven to be especially effective at ensuring a uniform course of the process.

Moreover, it can be advantageous to bring the material in an upstream process to a temperature close to the process temperature. This holds especially for polymers with low inertia and/or long diffusion time.

Furthermore, the removal of contamination also decreases the noxious odors.

The dwell time ensures that a minimum purification of the material occurs and depends on different criteria, namely, the diffusion rate of the migration products in the corresponding polymer and the softening or melting temperature of the polymer.

The dwell time can become very long for certain polymers. So as not to melt the material at the temperatures prevailing in the reactor, it may be expedient to subject the particles directly to an extrusion process with degassing of the melt. This holds in particular for LDPE, HDPE, PS and/or PP. One can usually dispense with a degassing of the melt for the polymers PC and PEN.

It is advantageous for the extruder to be coupled directly to the tank, and the vacuum advantageously reaches down to the melt region and at the same time as much stored energy in the flakes as possible is carried along into the extruder or the downstream extruder melts² under vacuum. ²As printed, there is probably a grammatical error in the original German patent.

To prevent energy losses from occurring through transport steps between treatment tank and extruder, measures can be taken, such as transport facilities, insulation, additional vacuum in the melting zone, etc.

In the melting zone of the extruder and in the downstream melt degassing, the last volatile components are removed at higher temperature under vacuum.

For the polymers PC and PEN, degassing of the melt can be omitted. But the degassing effect is of benefit in the melting zone.

Finally, the melt can be taken as needed on to a filtration, a granulation or a subsequent manufacturing step for the manufacture of an end product or a semifinished product.

The method of the invention for the pretreatment, reprocessing or recycling of thermoplastic synthetic material in all its advantageous embodiments is normally carried out in a receiving tank or reactor. The synthetic material being treated is placed in this receiving tank or reactor and treated under constant mixing or movement and/or comminution at elevated temperature.

For mixing and heating of the plastic material, a comminuting or mixing tool able to turn about a vertical axis arranged on at least one and possibly on several levels one above the other is arranged in the reactor, with working edges that act on the material with a comminuting and/or mixing effect. These comminuting or mixing tools apply mechanical energy to the polymer material, so that a heating and a simultaneous mixing and movement of the polymer material occurs. The heating occurs here by transformation of the applied mechanical energy.

Such reactors are also used in practice and are known, for example, as “EREMA Plastic Recycling System PC” or as “one- or two-stage VACUREMA layouts”.

The reprocessing occurs at a temperature below the melting temperature and preferably above the glass transition temperature of the plastic material, while the polymer material is moved and blended uniformly and steadily. In this way, the plastic material is crystallized, dried and purified in a single step.

The plastic materials for treatment are primarily polylactic acid (PLA), high density polyethylene (HDPE), low density polyethylene (LDPE), polypropylene (PP), polycarbonate (PC), polystyrene (PS), polyethylene naphthalate (PEN), polyamides (PA), polylimide (PI), polyhydroxyalkanoic acid (PHA), styrene copolymers, such as acrylonitrile-butadiene-styrene (ABS), styrene-acrylonitrile (SAN), polymethylmethacrylate (PMMA) and/or bioplastics, especially those based on starch, or starch blends. Mixtures of these plastic materials, such as PET/PE, PET/PA and PP/PA, are also used.

The plastic material is usually present in the form of at least partly crystallized or noncrystallized or amorphous granulate, new goods or regenerated goods. But it can also be present in the form of rather amorphous, comminuted film waste, especially from deep drawn applications, with a thickness especially between 100 μm and 2 mm, in the form of thin film waste from drawing plants with a thickness in particular between 5 μm and 100 μm and/or in the form of fiber and fleece wastes. Furthermore, the plastic material can be in the form of waste bottles or injection molded wastes.

The precise process parameters, especially the temperature, depend on the form and thickness of the material and of course the type of polymer itself.

The method for polymer piece goods, especially in the form of granulates, flakes or the like, is preferably carried out in a one-stage VACUREMA reactor. Such a reactor has the above indicated features and a vacuum can be applied to it.

For polymers in the form of thin films, fibers or fleeces, the method is advantageously carried out in a one-stage EREMA PC reactor. In this case, it is often also enough to carry out the method under ambient pressure, i.e., without vacuum. The reactor likewise has the above indicated features.

The method can also be carried out in two stages. Thus, for example, a mixture of crystallized and noncrystallized granulates or flakes can be placed as the material being purified in the crystallization dryer of a two-stage VACUREMA reactor. In the upstream crystallization dryer are arranged comminuting and mixing tools rotating about a vertical axis, being outfitted with working edges acting on the material with a comminuting and/or mixing effect. These comminuting and mixing tools apply mechanical energy to the material, so that a preheating of the material and a simultaneous mixing and movement of the material occurs. Next, the preheated, predried material is subjected to the main treatment.

In order to carry out the method of the invention in advantageous manner, one can use, for example, a device that has a tank for the plastic being processed, to which this material is fed through an entrance opening and from which the material is brought out through at least one worm connected to the side wall of the tank, while in the bottom area of the tank there is arranged at least one tool able to rotate about a vertical axis and provided with working edges that act on the material with a comminuting and/or mixing effect, and the intake opening of the worm lies at least approximately at the height of the tool, and is preferably provided with at least one line connected to the tank to generate a vacuum and/or for gassing in the inside of the tank. Such a device is implemented, for example, as a VACUREMA reactor or as an EREMA PC reactor.

Such a process control is generally satisfactory, even when processing such kinds of plastics that are sensitive to the oxygen of air and/or humidity, since evacuation of the tank or introduction of a protective gas into the inside of the tank can protect the plastic material against these harmful influences.

However, it has been found that in many cases the degree of homogenization of the plastic material taken away through the worm is not sufficient, especially in regard to the achieved degree of drying of such plastic materials, which must be completely dry even before the plasticization in order to avoid degradation.

Films of greater thickness require a drying expense that increases with the thickness, so that such goods require separate drying processes, e.g., with dehydrogenated air, in special dryers. These dryers, furthermore, work in a temperature range for which only crystallized material is permissible; amorphous material would become sticky and thus get caked.

This means that a crystallization process must come before the drying process. But if the material being processed in the tank is processed by the tool for a long time, the danger exists, especially for continuous duty of the device, that individual plastic particles will be caught up by the exit worm very early, while other plastic particles only much later. The early captured plastic particles may still be relatively cold and therefore not sufficiently pretreated, so that inhomogeneities are created in the material taken through the worm to the attached tool, e.g., an extruder head.

To avoid this and significantly improve the homogeneity of the exiting material, the method of the invention can be operated in another device, in which the entrance opening of the main tank is connected to the exit opening of at least one other tank, in which likewise at least one tool rotating about a vertical axis is provided in the bottom region of the tank. Thus, two or more tanks are arranged in series and the plastic material being processed must move through these tanks in series. In the first tank, already precomminuted, preheated, predried and precompressed and thus prehomogenized material is produced, which is placed in the following tank. This ensures that no untreated, i.e., cold, uncompressed, uncomminuted or inhomogeneous material goes directly to the exit worm and through this to the attached extruder or the like.

These benefits will also be secured if a vacuum or protective gas treatment of the thermoplastic material occurs in the second and/or a following tank. The overflow cross section is generally small and the pressure equalization is greatly throttled by the material transport. Furthermore, the mixing clot formed in the upstream tank closes the exit opening of this tank and therefore likewise acts as a seal to some extent.

The relations then become especially favorable if the exit opening of the additional tank, i.e., the upstream tank, lies at least approximately at the level of the tool in this tank, i.e., in the bottom region of the tank. The tool rotating in this tank then feeds to the exit opening through centrifugal force, so that the overflow cross section is always well filled with material.

According to one advantageous modification, the exit opening is connected to the entrance opening by means of a pipe socket, in which a shutoff element is arranged. In this way, a complete seal can be achieved between the two tanks, so that losses of vacuum or protective gas are entirely avoided. In the most simple case, this shutoff element can be a slide gate, which is closed as soon as the vacuum treatment or the gassing takes place in the downstream tank. But in this case, a full continuous duty is no longer possible. But if, according to a preferred embodiment of the invention, the shutoff element is a sluice, especially a cellular wheel sluice, the mentioned seal between the two tanks is maintained and a continuous duty is still possible. The cells of the sluice can likewise be gassed or evacuated in familiar fashion.

The vacuum formed in the downstream tank supports the intake of the material being processed from the upstream tank. In such layouts, therefore, the tanks can be arranged at the same height. But if one wishes to improve the filling of the downstream tank by the action of gravity, according to one modification of the invention the arrangement can be such that the tank upstream in the direction of flow of the material lies higher than the following tank. The latter can therefore be filled also in the middle region or in the upper region of its side wall and possibly also from above, through the top cover.

The method of the invention can, as described, also be carried out advantageously in two stages in a correspondingly configured device. In this process management, there is a two-stage treatment of the accruing or delivered material, while no plasticization of the material occurs in the course of the pretreatment in the pretreatment layout, but instead a crystallization and/or a certain precompacting with simultaneous drying. The precompacting is accomplished at appropriate temperature by mechanical action or input of energy into the material. In particular, the raising or adjusting of the temperature occurs by the mechanical action on the material by transforming the rotational energy of at least one mixing and/or comminuting element into thermal energy thanks to the frictional losses which occur.

In the course of the main treatment in the main treatment layout, the material is further dried at elevated temperature, detoxified and, if necessary, crystallized and held under high vacuum for a certain mean dwell time. Once again, there is a mechanical application or compression of material and adding of energy by means of at least one mixing or comminuting element, which by virtue of its rotation supplies the corresponding thermal energy to the material and further heats it.

The main treatment, which occurs under vacuum, diminishes the residual moisture to a given predetermined mean value and also ensures that volatile toxins are separated from the material.

The temperature during the main treatment is kept below the melt temperature of the material. However, one should try to set this temperature as high as possible.

After the treatment in the one-stage process or the main treatment in the two-stage process, the material taken away is advantageously plasticized by means of an extruder, preferably one connected indirectly³ to the main treatment layout. Thanks to the direct, vacuum-tight connection, the vacuum in the main treatment layout can reach into the entrance region of the extruder. The extruder often has a plasticization zone, adjoined by a compression and retention zone. This retention zone usually adjoins a degassing or evacuation zone, in which volatile substances are sucked out from the melt by vacuum, especially a high vacuum. There can be a one-stage or multiple-stage degassing; there can also be several compression and decompression zones with different vacuum in succession. Thus, even stubborn or hard to vaporize contaminants can be evaporated. ³“mittelbar”, indirect. The next sentence says “direct”, using the Latin, not the German form of the word (unmittelbar).

By proper choice of the temperatures and the dwell times in the pretreatment and in the main treatment, the viscosity value of the melt removed from the extruder and the granulate made from the melt can be adjusted. Thanks to appropriately long dwell times and correspondingly high temperatures in the vacuum, a positive influence is exerted on the viscosity and a repolymerization will occur.

Basically, it is not necessary to melt down the recycled, crystallized and dried plastic pieces. They can be stored while retaining their dried and crystallized condition, cooled down, or [taken?] via transport facilities to extrusion systems or be further processed [in?] other transformative processes.

Since it is hard to attain the crystallized state with the currently known systems, one can also forego maintaining the dried condition, which usually results in loss of quality in direct processing with a new drying process. If the material is dried again, this leads to loss of the invested drying energy.

The devices described precisely and specifically in the publications EP 123 771, EP 0 390 873, AT 396 900, AT 407 235, AT 407 970, AT 411 682, AT 411 235, AT 413 965, AT 413 673 or AT 501 154 along with all their advantageous embodiments are taken up into the present application and constitute an integral part of the disclosure. Such devices are also used in practice and are known, for example, as the “EREMA Plastic Recycling System PC” or as “one-stage or two-stage VACUREMA layouts”.

In what follows, several general examples of possible process management will be described, giving the range of possible parameters for different plastics:

### EXAMPLE 1

Polylactic acid (PLA) in the form of flakes from comminuted packages or granulates
is heated to a temperature of 65° to 120° C., preferably 90° to 110° C.,
stays in the reactor for an average dwell time of 10 min to 100 min, especially 20 min to 70 min,
wherein the circumferential velocity of the outermost agitation tips of the comminuting or mixing tool lies in a range of 1 to 35 m/s, preferably 3 to 20 m/s,
and wherein a vacuum of ≦150 mbar, preferably ≦50 mbar, especially ≦20 mbar, especially between 0.1 and 2 mbar, is applied.

### EXAMPLE 2

Polylactic acid (PLA) in the form of thin films, fibers or fleece
is heated to a temperature of 65° to 120° C., preferably 90° to 110° C.,
stays in the reactor for an average dwell time of 3 min to 60 min, especially 10 min to 25 min,
wherein the circumferential velocity of the outermost agitation tips of the comminuting or mixing tool lies in a range of 15 to 58 m/s, preferably 35 to 47 m/s,
and wherein the treatment occurs under ambient pressure.

### EXAMPLE 3

High density polyethylene (HDPE) in the form of flakes from comminuted packages
is heated to a temperature of 50° to 130° C., preferably 90° to 122° C.,
stays in the reactor for an average dwell time of 10 min to 100 min, especially 20 min to 70 min,
wherein the circumferential velocity of the outermost agitation tips of the comminuting or mixing tool lies in a range of 1 to 35 m/s, preferably 3 to 20 m/s,
and wherein a vacuum of ≦150 mbar, preferably ≦50 mbar, especially ≦20 mbar, especially between 0.1 and 2 mbar, may be applied.

### EXAMPLE 4

Low density polyethylene (LDPE) in the form of flakes from comminuted packages
is heated to a temperature of 50° to 110° C., preferably 75° to 105° C.,
stays in the reactor for an average dwell time of 10 min to 100 min, especially 20 min to 70 min,
wherein the circumferential velocity of the outermost agitation tips of the comminuting or mixing tool lies in a range of 2 to 35 m/s, preferably 3 to 20 m/s,
and wherein a vacuum of ≦150 mbar, preferably ≦50 mbar, especially ≦20 mbar, especially between 0.1 and 2 mbar, may be applied.

### EXAMPLE 5

Polypropylene (PP) in the form of flakes from comminuted packages
is heated to a temperature of 50° to 155° C., preferably 100° to 150° C.,
stays in the reactor for an average dwell time of 10 min to 100 min, especially 20 min to 70 min,
wherein the circumferential velocity of the outermost agitation tips of the comminuting or mixing tool lies in a range of 2 to 35 m/s, preferably 3 to 20 m/s,
and wherein a vacuum of ≦150 mbar, preferably ≦50 mbar, especially ≦20 mbar, especially between 0.1 and 2 mbar, may be applied.

### EXAMPLE 6

Polycarbonate (PC), especially in the form of flakes from comminuted packages,
is heated to a temperature of 110° to 240° C., preferably 130° to 210° C.,
stays in the reactor for an average dwell time of 30 min to 200 min, especially 40 min to 120 min,
wherein the circumferential velocity of the outermost agitation tips of the comminuting or mixing tool lies in a range of 2 to 35 m/s, preferably 3 to 20 m/s,
and wherein a vacuum of ≦150 mbar, preferably ≦50 mbar, especially ≦20 mbar, especially between 0.1 and 2 mbar, may be applied.

### EXAMPLE 7

Polystyrene (PS) in the form of flakes from comminuted packages
is heated to a temperature of 50° to 110° C., preferably 75° to 105° C.,
stays in the reactor for an average dwell time of 10 min to 100 min, especially 20 min to 70 min,
wherein the circumferential velocity of the outermost agitation tips of the comminuting or mixing tool lies in a range of 2 to 35 m/s, preferably 3 to 20 m/s,
and wherein a vacuum of ≦150 mbar, preferably ≦50 mbar, especially ≦20 mbar, especially between 0.1 and 2 mbar, may be applied.

### EXAMPLE 8

Polyethylene naphthalate (PEN), especially in the form of flakes from comminuted packages,
is heated to a temperature of 110° to 250° C., preferably 140° to 235° C.,
stays in the reactor for an average dwell time of 30 min to 200 min, especially 40 min to 120 min,
wherein the circumferential velocity of the outermost agitation tips of the comminuting or mixing tool lies in a range of 2 to 35 m/s, preferably 3 to 20 m/s,
and wherein a vacuum of ≦150 mbar, preferably ≦50 mbar, especially ≦20 mbar, especially between 0.1 and 2 mbar, may be applied.

1. Method for the pretreatment, reprocessing or recycling of thermoplastic material, especially of wastes in any form, wherein the plastic material being treated is heated in at least one receiving tank or reactor under constant mixing or movement and/or comminution at a temperature below the melting temperature, preferably over the glass transition temperature of the plastic, and thereby at the same time crystallized, dried and/or purified, especially in a single step, wherein for mixing and heating of the plastic material, at least one comminuting or mixing tool able to turn about a vertical axis arranged possibly on several levels one above the other is used, with working edges that act on the material with a comminuting and/or mixing effect, and the heating occurs especially by applying mechanical energy.

2. Method according to claim 1, characterized in that the plastic materials used are polylactic acid (PLA), high density polyethylene (HDPE), low density polyethylene (LDPE), polypropylene (PP), polycarbonate (PC), polystyrene (PS), polyethylene naphthalate (PEN), polyamides (PA), polylimide (PI), polyhydroxyalkanoic acid (PHA), styrene copolymers, such as acrylonitrile-butadiene-styrene (ABS), styrene-acrylonitrile (SAN), polymethylmethacrylate (PMMA) and/or bioplastics, especially those based on starch, or starch blends or mixtures of these plastic materials, such as PET/PE, PET/PA and PP/PA.

3. Method according to claim 1, characterized in that plastic material is used in the form of partly crystalline or amorphous granulates, flakes of comminuted packages, new goods or regenerated goods, in the form of partly crystalline or amorphous, comminuted film waste, especially from deep drawn applications, with a thickness especially between 100 μm and 2 mm, in the form of thin film waste from drawing plants with a thickness in particular between 5 μm and 100 μm and/or in the form of fiber and fleece wastes.

4. Method according to claim 1, characterized in that the plastic material, especially in the form of flakes from comminuted packages and/or granulates, is moved or mixed at a circumferential velocity of the outermost agitation tips of the comminuting or mixing tool of 1 to 35 m/s, preferably 3 to 20 m/s.

5. Method according to claim 1, characterized in that the plastic material, especially polylactic acid (PLA), especially in the form of thin films, fibers or fleece with a thickness of especially between 100 μm and 2 mm, is moved or mixed at a circumferential velocity of the outermost agitation tips of the comminuting or mixing tool of 15 to 58 m/s, preferably 35 to 47 m/s.

6. Method according to claim 1, characterized in that the plastic material, especially in the form of flakes from comminuted packages and/or granulates, is treated under a vacuum of ≦150 mbar, preferably ≦50 mbar, especially ≦20 mbar, especially between 0.1 and 2 mbar.

7. Method according to claim 1, characterized in that the plastic material, especially polylactic acid (PLA), especially in the form of thin films, fibers or fleece, is treated under ambient pressure.

8. Method according to claim 1, characterized in that plastic materials, especially of polylactic acid (PLA), high density polyethylene (HDPE), low density polyethylene (LDPE), polypropylene (PP), polyamides (PA) and/or polystyrene (PS), especially in the form of flakes from comminuted packages and/or granulates, stay in the reactor for an average dwell time of 10 min to 100 min, especially 20 min to 70 min.

9. Method according to claim 1, characterized in that plastic materials, especially those of polycarbonate (PC) and/or polyethylene naphthalate (PEN), especially in the form of flakes from comminuted packages and/or granulates, stay in the reactor for an average dwell time of 30 min to 200 min, especially 40 min to 120 min.

10. Method according to claim 1, characterized in that the plastic material, especially polylactic acid (PLA), in the form of films, fibers or fleece, stays in the reactor for an average dwell time of 3 min to 60 min, especially 10 min to 25 min.

11. Method according to claim 1, characterized in that plastic material from polylactic acid (PLA) is heated to a temperature of 65° to 120° C., preferably 90° to 110° C.

12. Method according to claim 1, characterized in that plastic material from high density polyethylene (HDPE) is heated to a temperature of 50° to 130° C., preferably 90° to 122° C.

13. Method according to claim 1, characterized in that plastic material from low density polyethylene (LDPE) is heated to a temperature of 50° to 110° C., preferably 75° to 105° C.

14. Method according to claim 1, characterized in that plastic material from polypropylene (PP) is heated to a temperature of 50° to 155° C., preferably 100° to 150° C.

15. Method according to claim 1, characterized in that plastic material from polycarbonate (PC) is heated to a temperature of 110° to 240° C., preferably 130° to 210° C.

16. Method according to claim 1, characterized in that plastic material from polystyrene (PS) is heated to a temperature of 50° to 110° C., preferably 75° to 105° C.

17. Method according to claim 1, characterized in that plastic material from polyethylene naphthalate (PEN) is heated to a temperature of 110° to 250° C., preferably 140° to 235° C.

18. Method according to claim 1, characterized in that the process is run as a single stage in a single reactor and the plastic material is heated, dried, crystallized and purified in a single work process, especially in a single reactor.

19. Method according to claim 1, characterized in that the process is run with or without predrying and/or with or without precrystallization of the plastic material.

20. Method according to claim 1, characterized in that the process is run in many stages, especially two stages, while two or more receiving tanks or reactors are arranged in series and/or in parallel and the plastic material being processed runs through these tanks in series.

21. Method according to claim 20, wherein during the steps of reprocessing or recycling of thermoplastic material, especially of wastes in any form, the plastic material being treated is heated in at least one receiving tank or reactor under constant mixing or movement and/or comminution at a temperature below the melting temperature, preferably over the glass transition temperature of the plastic, and thereby at the same time crystallized, dried and/or purified, especially in a single step, wherein for mixing and heating of the plastic material, at least one comminuting or mixing tool able to turn about a vertical axis arranged possibly on several levels one above the other is used, with working edges that act on the material with a comminuting and/or mixing effect, and the heating occurs especially by applying mechanical energy are used for at least one tank, especially for the first one filled, or for the pretreatment.

22. Method according to claim 20, characterized in that the plastic material, especially comprising polymers with low inertness and/or long diffusion time, is brought in an upstream pretreatment to a temperature, especially close to the process temperature of the main treatment.

23. Method according to claim 20, characterized in that the plastic material in the first stage is subjected to a pretreatment, especially under vacuum conditions, by application of mechanical energy, and is thereby heated and dried at elevated temperature, and possibly crystallized at the same time, and then in a second stage preceding a general plasticization or melting there occurs a main treatment of the plastic material, especially under vacuum conditions, it is dried once more by application of mechanical energy under movement and further crystallized, while this main treatment occurs in particular at a temperature higher than the pretreatment.

24. Method according to claim 20, characterized in that the plastic material prior to the pretreatment is subjected to a precomminution and/or washing and/or predrying.

25. Method according to claim 20, characterized in that the temperature of the main treatment is kept below the plasticization temperature or melt temperature of the plastic material.

26. Method according to claim 20, characterized in that the plastic material is subjected to the pretreatment in a continuous flow.

27. Method according to claim 1, characterized in that the method is run continuously or discontinuously or as a batch process.

28. Method according to claim 1, characterized in that the plastic material is finally plasticized or melted down and then, possibly after a filtration, especially under vacuum conditions, taken to an extruder or processed into a granulate.
